(19) United States
(12) Patent Application Publication
(10) Pub. No.: US 2006/0109904 A1
(43) Pub. Date: May 25, 2006

(54) Decoding apparatus and program for executing decoding method on computer

(76) Inventor: Koichi Hamada, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/063,634

(22) Filed: Feb. 24, 2005

(30) Foreign Application Priority Data
Nov. 22, 2004 (JP) 2004-336862

(51) Int. Cl. H04N 11/02; H04N 11/04; H04N 7/12; H04B 1/66

(52) U.S. Cl. 375/240.16; 375/240.25; 375/240.12; 375/240.24; 375/240.2; 375/240.03

(57) ABSTRACT

The generation of thumbnail images from encoded image data at high speed is carried out. In decoding encoded image data, without performing inverse DCT, only the DC coefficient among the DCT coefficients of each block is extracted. For an I picture, the DC coefficient is outputted as decoded data on the corresponding block. For a P picture and a B picture, a motion compensation value calculated based on the corresponding motion vector is added to the DC coefficient and the sum is used as the pixel value of the corresponding block. The calculation to be made for motion compensation can be greatly simplified by reducing the motion vector accuracy to an eight-pixel accuracy (an accuracy corresponding to a unit of a block), making it possible to generate thumbnail images at high speed.

### CLAIM OF PRIORITY

The present application claims priority from Japanese application JP 2004-336862, filed on Nov. 22, 2004, the contents of which is hereby incorporated by reference into this application.

### FIELD OF THE INVENTION

The present invention relates to an image decoding apparatus for decoding MPEG image data, an image decoding method, and a program for executing the image decoding method.

### BACKGROUND OF THE INVENTION

To reproduce an encoded image requires decoding processing to be performed. There are cases in which it is not necessary to reproduce input images in complete form and in which reduced images good enough to roughly show the contents of each image or images with a low pixel density (hereinafter referred to as thumbnails) are acceptable.

For use in such cases, there is a technique for generating what is known as thumbnails, for example, from MPEG-encoded image data (see JP-A No. 219420/2003, for example). In this technique, thumbnails are generated using DC coefficients only out of block-based DCT coefficients that are generated in the process of MPEG encoding. More specifically, DC coefficients, among DCT coefficients, are used to decode an I picture, and DC coefficients, to each of which a motion compensation value has been added, are used to decode a P picture or a B picture. According to the method disclosed in the above-referenced patent, in generating a P picture or a B picture, motion vector values are used as they are for motion compensation; and, for interpolation, the DC coefficients of a maximum of four blocks of a reference image are added to by values corresponding to the relevant motion vector values.

For image decoding commonly performed involving motion compensation, there is a technique which reduces the amount of calculation to be made by lowering the motion compensation accuracy so as to enable high-speed image decoding (see JP-A No. 322175/1997, for example). In this technique, for only B pictures, which do not cause propagation of the motion compensation accuracy to other pictures, the motion vector accuracy is reduced to an integer pixel accuracy on the demodulator side, so as to omit the calculation for pixel interpolation required when making motion vector compensation with a fractional pixel accuracy, and, thereby, the amount of calculation to be made is reduced.

### SUMMARY OF THE INVENTION

In the above-described technique to generate thumbnails from MPEG-encoded data, for P pictures and B pictures requiring motion compensation, reference image pixel interpolation is calculated according to motion vector values. In the interpolation calculation, the DC coefficients of a maximum of four blocks of a reference image are added to by values corresponding to the relevant motion vector values to obtain the DC coefficients for locations determined according to the motion vectors. This technique involves a large amount of calculation, so that there have been cases in which high-speed decoding has been prevented by interpolation processing. In the technique disclosed in JP-A No. 322175/1997, the motion vector accuracy is simply reduced to an integer pixel accuracy on the decoding side. Even if the technique is applied to the above-mentioned thumbnail generation technique, interpolation calculation is still required for thumbnails having only one reference image pixel value per block.

The present invention, which has been made in view of the above-described circumstances, provides an image reproducing apparatus which, in generating thumbnails using DC coefficients only among MPEG DCT coefficients, simplifies the processing used to generate predicted images for motion compensation, and, thereby, thumbnail generation at high speed is possible.

The representative elements of the invention disclosed in the present application are as follows.

In decoding motion compensated, encoded images, reduced images (thumbnails) are generated using DC coefficients only among the DCT coefficients of each block, without involving inverse DCT transformation. In generating reduced images, DC coefficients among the DCT coefficients of the relevant blocks are used as they are in the case of I pictures; and, in the case of P and B pictures, the DC coefficients are added to by motion compensation values determined according to the relevant motion vectors. Furthermore, in terms of the motion compensation, the motion vector accuracy is changed to correspond to an integral multiple of a block.

With the above arrangement, the amount of processing to be made by a decoder is reduced. Reducing the motion vector accuracy to an accuracy corresponding to the unit of a block (eight pixels, for example) causes the image quality to slightly deteriorate; however, by doing so, the amount of calculation to be made for motion compensation can be greatly reduced, making it possible to generate and reproduce thumbnails at high speed.

### BRIEF DESCRIPTION OF THE DRAWINGS

FIG. 1 is a schematic block diagram of an image reproducing apparatus according to the present invention;

FIG. 2 is a block diagram of a conventional MPEG stream decoding apparatus;

FIG. 3 is a diagram showing a relationship between a predicted image and a reference image in a case in which a conventional method is used;

FIG. 4 is a diagram showing a relationship between a predicted image and a reference image in a case in which a method according to the present invention is used;

FIG. 5 is a block diagram showing an embodiment of a motion vector accuracy controller;

FIG. 6 is a diagram showing an example of a thumbnail display on a screen according to the present invention; and

FIG. 7 is a block diagram showing an embodiment of a thumbnail display device according to the present invention.

### DETAILED DESCRIPTION OF THE PREFERRED EMBODIMENTS

Embodiments of the present invention will be described with reference to drawings.

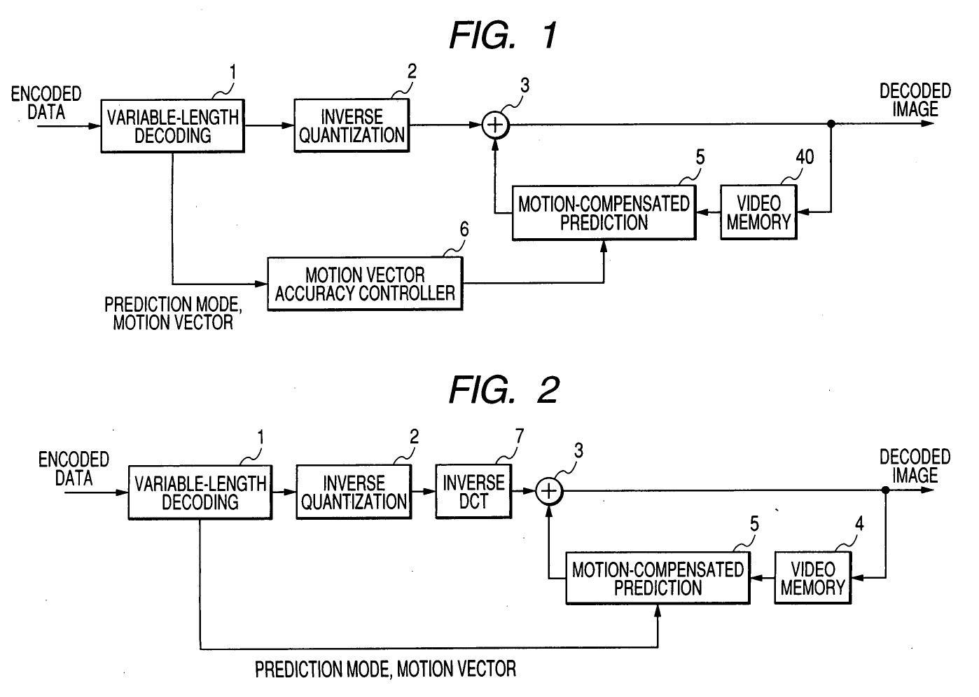

FIG. 1 shows the configuration of an image decoding and reproducing apparatus for generating video thumbnails according to an embodiment of the present invention. The thumbnails referred to in the present application may be either still image thumbnails or moving image thumbnails. Even though embodiments in which an MPEG-based encoding method is used will be described in the present application, the present invention can be applied to cases in which data encoded using motion compensation is decoded.

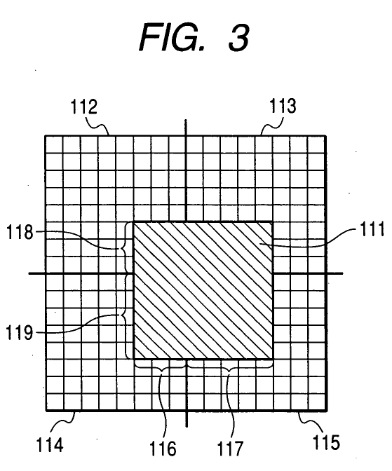

FIG. 2 shows a common type of decoding section for decoding MPEG data. An encoded bit stream enters a variable-length decoding section 1, where encoded information in macroblocks is decoded into encoding mode information, motion vector information, quantization information, and quantized DCT coefficients. The quantized DCT coefficients separated by decoding are reconverted into DCT coefficients in an inverse quantization section 2 and are then converted into pixel spatial data in an inverse DCT section 7. When an intra-encoding mode is used, the pixel spatial data obtained is outputted, as it is, as decoded image data. In a motion compensated prediction section 5, block data on a predicted image, generated by a motion prediction that is made using the motion vector information and a reference image, is generated. When a motion compensation mode is used, the block data is added to the pixel spatial data in an addition section 3, and the data obtained as a result of the addition is then outputted. The reference image referred to above refers to an already decoded image. In the case of a P picture, it is stored in a video memory 4 for use as a reference image in a subsequent decoding process.

In the configuration according to the present invention, as shown in FIG. 1, the variable-length decoding section 1, the inverse quantization section 2, the addition section 3, and the motion compensated prediction section 5 operate in the same manner as described in terms of the configuration shown in FIG. 2. The configuration according to the present invention, as shown in FIG. 1, does not include the inverse DCT section 7. In accordance with the present invention, the DCT coefficients generated by inverse quantization performed in the inverse quantization section 2 are not subjected to inverse DCT, so that the DC coefficients, among the DCT coefficients, are processed as they are. In MPEG encoding, an image is processed in plural blocks. Each block is composed of, for example, eight-by-eight pixels. The number of DCT coefficients outputted from the inverse quantization section 2 equals the number of pixels in the blocks of pixels. A DCT coefficient of a block represents the spatial frequency component of the value of a pixel in the block. The value representing the DC coefficient (DCT coefficient at coordinates (0, 0)) among the DCT coefficients may be considered to represent the average pixel value of the block. Therefore, outputting only the DC coefficient of a block, as it is, is equivalent to outputting the average pixel value (average luminance value or average color difference value) of the block. Each block has one DC coefficient. Therefore, an image generated using only the DC coefficients, with each block composed of eight-by-eight pixels, is one-eight the original encoded image in terms of both the vertical and the horizontal dimensions. The decoded image thus generated is stored in a video memory 40 for use as a reference image in making motion compensation for images to be processed subsequently.

For an I picture, a thumbnail image can be obtained by outputting the corresponding DC values as they are. Generating a P picture or a B picture involves interframe motion compensation. To generate a P picture or a B picture, it is necessary to perform motion compensation using motion vectors and a reference image and then to calculate DC coefficients for the locations corresponding to the motion vectors. Motion compensation is effected by adding the values of decoded blocks of an image being processed and the values obtained by performing motion-compensated prediction based on a decoded reference image.

Referring to FIG. 3, a predicted block 111 is a block obtained by making a motion-compensated prediction for a block being processed. Generally, a motion vector is transmitted with fractional-pixel accuracy, such as ½ or ¼ pixel accuracy for accuracy enhancement. In the image decoding and reproducing apparatus in which images are generated using only DC coefficients out of the DCT coefficients, each reference image stored in the video memory 40 is composed of DC coefficients only of its blocks. In the example shown in FIG. 3, the predicted block 111 is overlapped by blocks 112, 113, 114, and 115 stored as a reference image. Note that, in the present description, the stored DC coefficients out of the DCT coefficients of the blocks 112, 113, 114, and 115 are referred to as b1, b2, b3, and b4, respectively. In the configuration according to the present embodiment, it is necessary to calculate the pixel value of the predicted block 111 using the stored DC coefficients.

The pixel value bc of the predicted block 111 can be obtained, for example, by an interpolation method based on the DC coefficients of the stored reference image as follows:

bc=(x1*y1*b1+x2*y1*b2+x1*y2*b3+x2*y2*b4)/64 (3)

where, in terms of the sides in the x- and y-directions of the predicted block 111, x1 represents the length 116 of the portion of the side in the x-direction falling on the reference block 114, x2 represents the length 117 of the portion of the side in the x-direction falling on the reference block 115, y1 represents the length 118 of the portion of the side in the y-direction falling on the reference block 112, and y2 represents the length 119 of the portion of the side in the y-direction falling on the reference block 114. Also, the DC coefficient b of the predicted block, after motion compensation, can be obtained by the following equation:
b=bc+bp (4)
where bp represents DC coefficient data on the predicted block.

As described above, by carrying out an interpolation using a reference image, it is possible to generate a P picture or a B picture composed of DC coefficients only. However, the equation (3) for interpolation involves much calculation. Since it is necessary to calculate the equation (3) (involving eight multiplications, three additions, and one division) for every block, to obtain a full-screen image requires a considerable amount of calculation to be made, thereby taking a lengthy processing time.

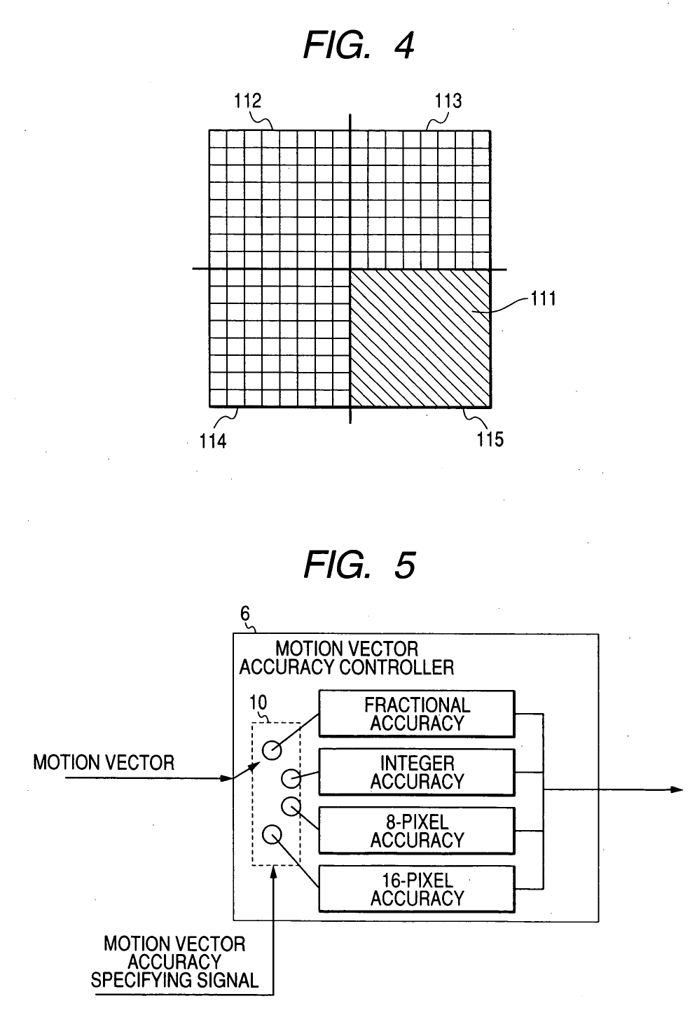

In the following, a decoding method which does not involve an interpolation calculation required for motion compensation will be proposed. In concrete terms, the method involves reducing the motion vector accuracy to an 8-pixel accuracy, that is, an accuracy corresponding to the unit of a block, by using a motion vector accuracy controller 6. When the motion vector accuracy is reduced to an 8-pixel accuracy, as described above, it follows that a corresponding reference image composed of DC coefficients only will always include the pixels that correspond to the block being processed. The predicted block 111 that is located as shown in FIG. 3, for example, is approximated, when the motion vector accuracy is reduced to an 8-pixel accuracy, to the nearest reference block 115, as shown in FIG. 4. In this case, the DC coefficient that is stored, which is associated with the reference block 115, can be used as it is as the DC coefficient of the block being processed. It is then unnecessary to perform an interpolation calculation as represented by the equation (3), so that thumbnails can be generated at a high speed.

Examples of equations for reducing the motion vector accuracy to an 8-pixel accuracy are shown below. A motion vector is composed of a motion vector h in the horizontal direction and a motion vector v in the vertical direction. The motion vector h′ in the horizontal direction and the motion vector v′ in the vertical direction, when the motion vector accuracy is reduced to an 8-pixel accuracy, are given by the following equations:
h′=sign(h)·{|h/8|]·8
v′=sign(v)·[|v/8|]·8
where sign (x) is a function whose value is +1 when x is a positive value, 0 when x is 0, or −1 when x is a negative value, |x| is an absolute value of x, and [x] is an integer value not exceeding x.

When, as a result of making calculations using the above-referenced equations, a reference macroblock is found to be overlapping plural macroblocks, one of the blocks overlapping the macroblock being processed is selected. This processing has the objective of approximating vectors based on blocks, and any other method of approximation may be used to achieve the same objective. For example, without using the above-referenced equations, a method for approximating the block being processed to a block with a large overlapping portion may be used. A method with a small approximation error leads to small image quality deterioration, and a method with a large approximation error leads to large image quality deterioration. In a case in which the image quality does not matter, it is conceivable to make an approximation by setting all motion vectors to 0 (no motion).

For the above-described embodiment, a processing performed in units of an eight-by-eight pixel block has been described. Depending on the required thumbnail size, however, a similar processing may be performed in larger units, for example, in units of a 16-by-16 pixel macroblock. In that case, an image that is reduced to 1/16 the original image in terms of both the vertical and the horizontal dimensions is generated. With a DC coefficient given for each block, it is necessary to generate a DC coefficient for each macroblock to be processed. For that purpose, a method to adopt the DC coefficient associated with an overlapping block, among the four eight-by-eight pixel blocks, or a method to use a DC coefficient obtained by calculating the average DC coefficient of the four eight-by-eight pixel blocks, may be used. For example, as a method of block selection, a block with a large overlapping portion may be selected, as described above. Whatever method is used, the reference images stored in the video memory 40 are also reduced images, with each macroblock being composed of a single value.

As described above, a configuration according to the present invention, in which the motion vector accuracy is reduced to an accuracy corresponding to an integral multiple of a block to be processed (for example, a unit of 16 pixels), makes interpolation calculation involved in motion compensation unnecessary and enables thumbnails to be generated at high speed. In the present embodiment, the blocks to be processed are larger than those in the first embodiment, so that the number of accesses to be made to memory is reduced, and so that the amount of calculation to be performed for motion compensation is also reduced. As a result, thumbnails can be generated at a higher speed.

FIG. 7 shows a thumbnail display device to which the present invention is applied. A stream of encoded image data outputted from a stream reproducing section 30 is inputted to a thumbnail generating section 31 where thumbnails are generated. The thumbnails thus generated are outputted for display at an output section 32. The parts of the thumbnail generating section 31 are equivalent to the parts shown in FIG. 1. The motion vector accuracy involved in thumbnail generation is controlled by a controller 35.

In a case in which a user specifies a thumbnail size at a user input section 34, the motion vector accuracy may be adjusted according to the specified thumbnail size by the motion vector controller 6. When, for example, thumbnails, each ⅛ times as large as the original image in terms of both the horizontal and the vertical dimensions, are desired by the user, the motion vector accuracy is to be reduced to an accuracy corresponding to a unit of 8 pixels. If thumbnails, each 1/16 times as large as the original image in terms of both the horizontal and the vertical dimensions, are desired by the user, the motion vector accuracy is to be reduced to a 16-pixel accuracy. Or, if thumbnails with little image quality deterioration are desired by the user, motion compensation may be made without reducing the fractional-pixel motion vector accuracy. In such a case, a configuration in which the pixel values of the corresponding locations are obtained by making an interpolation calculation, as described above, may be used. Or, a configuration as shown in FIG. 1 may be separately provided.

Switching of the motion vector accuracy, as described above, is to be carried out for each frame to be processed. To direct switching of the motion vector accuracy, an arrangement in which the user can select a desired accuracy displayed in a display section, or an arrangement in which the user can directly input a desired accuracy value, may be used. It is also possible to have the user input a desired thumbnail size, allowing the device to automatically set the motion vector accuracy corresponding to the specified thumbnail size. For example, motion vector accuracy values associated with sizes of decoded images may be stored beforehand, so that, when a thumbnail size that is ⅛ as large as the original image, both in terms of the vertical and the horizontal dimensions, is desired, the motion vector accuracy can be automatically reduced to an 8-pixel accuracy based on the stored data.

A method in which the motion vector accuracy is switched not according to the output thumbnail size, but according to the processing load of a decoder, is also conceivable. For example, in a case in which a software decoder is used, a load factor calculating section to calculate the load factor of a processor (CPU) on which the software decoder operates may be included, for example, in the control section 35. It is then possible to switch the motion vector accuracy for thumbnails to be generated according to the calculated load factor, thereby adjusting the image quality and controlling the amount of calculation to be made. More specifically, motion vector accuracy values associated with values of the load factor may be stored beforehand, making it possible to select a motion vector accuracy according to the calculated load factor.

As described above, providing a configuration for switching the motion vector accuracy makes it possible to select the thumbnail image quality and the speed of decoding according to a user's request. When the user does not require a high image quality, thumbnails can be generated at higher speed by adopting a simpler method for decoding encoded image data.

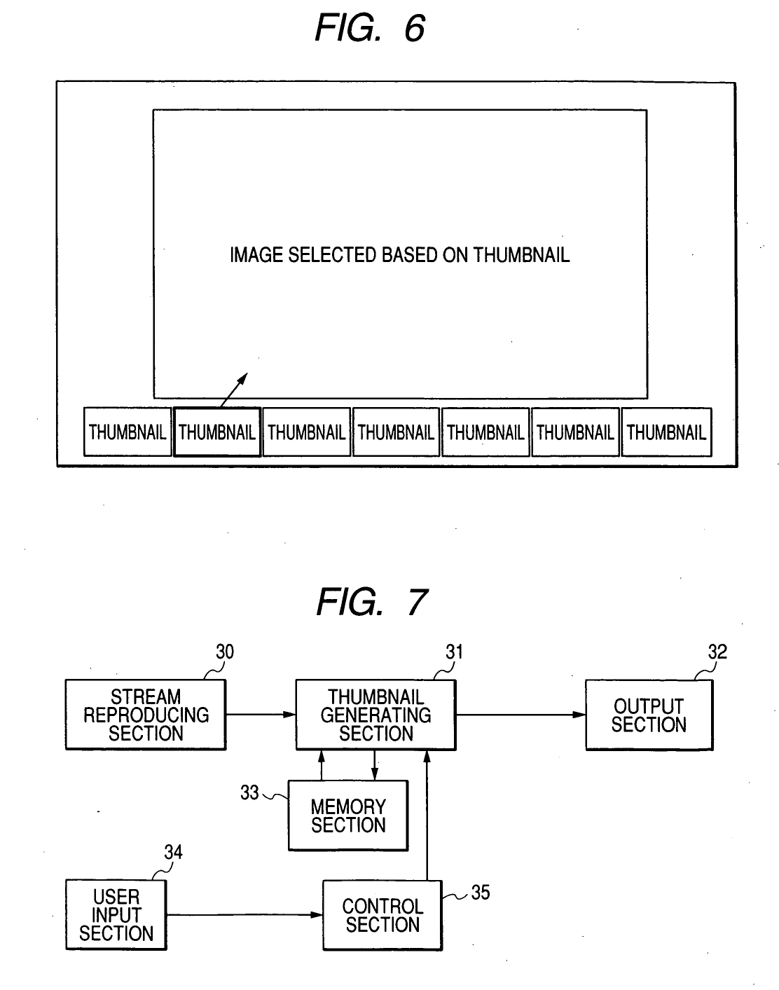

FIG. 6 shows an embodiment in which the present invention is applied to a video display device. Since the amount of processing required to generate thumbnails is reduced according to the present invention, thumbnails can be displayed quickly. In addition, such applications as scene detection and clip detection can be carried out by analyzing thumbnails and using known technology.

When thumbnails are required, for example, for the purpose of detecting a scene change point in a sequence of successive images or for checking the video content in editing video, some image quality deterioration is tolerated. In such a case, application of the present invention makes it possible to generate thumbnails with an image quality that is good enough for video analysis purposes at high speed and to display generated thumbnails side-by-side at the bottom of a display screen to enable efficient image browsing.

According to the present embodiment, when one of the thumbnails displayed side-by-side at the bottom of a screen is selected by an input section, an image associated with the selected thumbnail is displayed above the thumbnail display area of the screen or over the entire screen. It is preferable that the decoded image thus displayed is an image decoded in a normal fashion (without reducing the motion vector accuracy). Hence, when using the motion vector accuracy controller 6 of the above-described embodiment, encoded image data is decoded with a fractional-pixel motion vector accuracy or an unreduced motion vector accuracy. By doing so, thumbnails can be displayed at high speed; and, when a thumbnail is selected, an associated image whose quality has not deteriorated can be viewed.

The present invention may be implemented, for example, by providing a required hardware configuration, by providing an arrangement to read in and execute a software program, or by making combined use of hardware and software to effect the required processing.

What is claimed is:

1. A decoding apparatus comprising:
a memory section which memorizes decoded reference images;
a motion compensated prediction section which generates predicted images based on inputted encoded image data by using the reference images, an accuracy control section which controls an accuracy of motion vectors to be used in the motion compensated prediction section; and
an output section which outputs images decoded using the generated predicted images,
wherein the reference images are each composed of DC components of a plurality of blocks making up an image, the blocks each having a DC component, and
the motion compensated prediction section generates the predicted images in the accuracy control section using the motion vectors with an accuracy changed to correspond to an integral multiple of a unit of the blocks.

2. The decoding apparatus according to claim 1, wherein the accuracy control section changes the accuracy of motion vectors for each frame to be processed by selecting one of a plurality of prepared integral multiples of a unit of the blocks.

3. The decoding apparatus according to claim 1, wherein the accuracy control section comprises a section which switches between execution and inexecution of changing the accuracy of motion vectors.

4. The decoding apparatus according to claim 2, wherein the accuracy control section comprises a section which switches between execution and inexecution of changing the accuracy of motion vectors.

5. The decoding apparatus according to claim 2 further comprising an input section, wherein the accuracy control section selects the accuracy of motion vectors based on directive information inputted via the input section.

6. The decoding apparatus according to claim 3 further comprising an input section, wherein the accuracy control section selects the accuracy of motion vectors based on directive information inputted via the input section.

7. The decoding apparatus according to claim 5, wherein the directive inputted via the input section specifies a size of decoded images to be displayed and the accuracy control section selects an accuracy associated with the size of decoded images.

8. The decoding apparatus according to claim 6, wherein the directive inputted via the input section specifies a size of decoded images to be displayed and the accuracy control section selects an accuracy associated with the size of decoded images.

9. The decoding apparatus according to claim 1 further comprising a processing load calculating section, wherein the accuracy control section selects the accuracy of motion vectors according to output from the processing load calculating section.

10. The decoding apparatus according to claim 2 further comprising a processing load calculating section, wherein the accuracy control section selects the accuracy of motion vectors according to output from the processing load calculating section.

11. The decoding apparatus according to claim 3 further comprising a processing load calculating section, wherein the accuracy control section selects the accuracy of motion vectors according to output from the processing load calculating section.

12. The decoding apparatus according to claim 1 further comprising a display unit which displays a plurality of the decoded images side-by-side.

13. The decoding apparatus according to claim 2 further comprising a display unit which displays a plurality of the decoded images side-by-side.

14. The decoding apparatus according to claim 3 further comprising a display unit which displays a plurality of the decoded images side-by-side.

15. A program to execute a decoding method for decoding encoded image data on a computer, wherein the decoding method comprises:
separating quantized DCT coefficients of and motion vector information on each block from inputted encoded image data;
changing the accuracy of motion vectors to correspond to an integral multiple of a unit of the blocks;
generating predicted images by making motion compensated prediction using decoded reference images and the separated motion vector information; and
synthesizing decoded images by inversely transforming the quantized DCT coefficients and adding the inversely transformed DCT coefficients and the predicted images,
where the reference images each are composed of DC coefficients of the blocks, the blocks each having a DC component.

16. The program according to claim 15, wherein the decoding method further comprises switching frame by frame the accuracy of motion vectors to an accuracy corresponding to an integral multiple of a unit of the blocks.
